(19) United States
(12) Patent Application Publication
(10) Pub. No.: US 2025/0307022 A1
(43) Pub. Date: Oct. 2, 2025

(54) OPTIMIZATION OF A RATIO TO IDENTIFY WHEN AN APPLICATION IS OVER-PROVISIONED OR UNDER-PROVISIONED IN A DATA CENTER

(71) Applicant: Karthik Krishna, bangalore (IN)

(72) Inventor: Karthik Krishna, bangalore (IN)

(21) Appl. No.: 18/827,847

(22) Filed: Sep. 9, 2024

Related U.S. Application Data
(60) Provisional application No. 63/573,440, filed on Apr. 2, 2024.
(60) Provisional application No. 63/573,442, filed on Apr. 2, 2024.
(60) Provisional application No. 63/573,443, filed on Apr. 2, 2024.
(60) Provisional application No. 63/573,446, filed on Apr. 2, 2024.
(60) Provisional application No. 63/573,450, filed on Apr. 2, 2024.

(51) Int. Cl. G06F 9/50

(52) U.S. Cl. CPC G06F 9/5055; G06F 2209/5022

(57) ABSTRACT

A computerized method for determining a ratio to identify when an application is over-provisioned or under-provisioned in a data center in a data center comprising: performing Application Discovery and Dependency Mapping (ADDM) of one or more individual applications of the data center; with an ADDM output from the ADDM, generating an ADDM graph; determining each component of each individual application of one or more individual applications of the data center, wherein a component comprises a hardware component or a software component of each individual application; implementing a components mapping of each component of each individual application into the ADDM graph, wherein, with the ADDM graph, a plurality of components are represented as nodes and the connectivity between the nodes represented as edges, wherein based on a knowledge of the data-center environment, wherein each component is identified to correspond to each hardware component or each software component; implementing a workload in the data center, wherein the workload comprises a set of one or more tasks which are performed over a time period towards a specific goal; implementing a workload manager, wherein the workload manager executes the set of tasks in the workload, wherein a path of execution of the set of tasks is defined as the workflow; with the ADDM, ADDM graph and Component Resource Utilization, for the application: calculating a cost of each workload of the application; calculating a cost of running the application in the data center based on the cost of each workload of the application; and determining a ratio to identify when the application is over-provisioned or under-provisioned in the data center.

### CLAIMS OF PRIORITY

This application claims priority to U.S. Provisional Patent Application No. 63/573,440, filed on Apr. 2, 2024, and titled DATA CENTER METHODS. This provisional patent application is hereby incorporated by reference in its entirety.

This application claims priority to U.S. Provisional Patent Application No. 63/573,442, filed on Apr. 2, 2024, and titled DATA CENTER METHODS. This provisional patent application is hereby incorporated by reference in its entirety.

This application claims priority to U.S. Provisional Patent Application No. 63/573,443, filed on Apr. 2, 2024, and titled DATA CENTER METHODS. This provisional patent application is hereby incorporated by reference in its entirety.

This application claims priority to U.S. Provisional Patent Application No. 63/573,446, filed on Apr. 2, 2024, and titled DATA CENTER METHODS. This provisional patent application is hereby incorporated by reference in its entirety.

This application claims priority to U.S. Provisional Patent Application No. 63/573,450, filed on Apr. 2, 2024, and titled DATA CENTER METHODS. This provisional patent application is hereby incorporated by reference in its entirety.

### SUMMARY OF THE INVENTION

In one aspect, a computerized method for determining a ratio to identify when an application is over-provisioned or under-provisioned in a data center comprising: performing Application Discovery and Dependency Mapping (ADDM) of one or more individual applications of the data center; with an ADDM output from the ADDM, generating an ADDM graph; determining each component of each individual application of one or more individual applications of the data center, wherein a component comprises a hardware component or a software component of each individual application; implementing a components mapping of each component of each individual application into the ADDM graph, wherein, with the ADDM graph, a plurality of components are represented as nodes and the connectivity between the nodes represented as edges, wherein based on a knowledge of the data-center environment, wherein each component is identified to correspond to each hardware component or each software component; implementing a workload in the data center, wherein the workload comprises a set of one or more tasks which are performed over a time period towards a specific goal; implementing a workload manager, wherein the workload manager executes the set of tasks in the workload, wherein a path of execution of the set of tasks is defined as the workflow; with the ADDM, ADDM graph and Component Resource Utilization, for the application: calculating a cost of each workload of the application; calculating a cost of running the application in the data center based on the cost of each workload of the application; and determining a ratio to identify when the application is over-provisioned or under-provisioned in the data center.

### BACKGROUND

Currently in a data center/CSP which is running hundreds of applications and thousands of jobs/workloads, there may be a need to provision the infrastructure based on specific compute, storage, networking, memory and performance requirements. However, when deployed in production or staging, it is not straightforward to know if the infrastructure is over-provisioned or under-provision based on the current load for either at an application level or at a workload level.

Additionally, in a data-center like environment, there can be many users creating many applications for various projects. Over time it may become challenging to track the different components and their inter-dependencies for a particular application. Application discovery and dependency mapping (ADDM) is the process of identifying the dependencies of individual components of the application. Results of an ADDM is a graph with these individual components represented as nodes and the connectivity between the nodes represented as edges. There are multiple methodologies for doing ADDM available in the market today. However, improvements to these methodologies are also desired.

### BRIEF DESCRIPTION OF THE DRAWINGS

FIG. 1 illustrates an example process for calculating a carbon footprint of an individual application in a data center, according to some embodiments.

FIG. 2 illustrates an example table of components resource utilization for IaaS model, according to some embodiments.

FIG. 3 illustrates an example table of components resource utilization for on-premise model, according to some embodiments.

FIG. 4 illustrates an example table of components resource usage for PaaS model, according to some embodiments.

FIG. 5 illustrates an example table of energy consumed in kw (kilo watt) for one (1) hour over average utilization specified, according to some embodiments.

FIG. 6 illustrates an example process for using components resource utilization and/or usage of the applications in a data center discovered to identify the carbon footprint of each of the application, according to some embodiments.

FIG. 7 illustrates an example process for Carbon Footprint Calculation of the Application, according to some embodiments.

FIG. 8 illustrates an example equation for Calculate the carbon footprint of each component with the formula per the GHG protocol, according to some embodiments.

FIG. 9 illustrates an example process 900 for analysis of workloads, according to some embodiments.

FIG. 10 illustrates another example process for, according to some embodiments.

FIG. 11 illustrates an example process for calculating a cost of a workload in a data center, according to some embodiments.

FIG. 12 illustrates another example of an equation for calculating an extrinsic cost, according to some embodiments.

FIG. 13 illustrates an example equation(s) for calculating an intrinsic cost, according to some embodiments.

FIG. 14 illustrates an example process to determine and optimize a ratio to identify if an application is over-provisioned or under-provisioned, according to some embodiments.

FIG. 15 illustrates an example equation for determining an overprovisioned ratio for a workload, according to some embodiments.

FIG. 16 illustrates another example set of equations for determining an overprovisioning for a workload, according to some embodiments.

The Figures described above are a representative set and are not an exhaustive with respect to embodying the invention.

### DESCRIPTION

Disclosed are a system, method, and article of manufacture for optimization of a ratio to identify when an application is over-provisioned or under-provisioned in a data center. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application can be a multi-tiered (or a single tiered) architecture with hardware and software components which work cohesively to perform specific tasks to execute a particular function. Multi-tiered in this definition implies multiple interconnected components or layers, each handling specific functionality. An application can be as common as a websites for a restaurant or as complex as ATM for banking. Application could span across a single or multiple data center.

Application Discovery and Dependency Mapping (ADDM) can automate the process of mapping transactions and applications to underlying infrastructure components.

‘Calculate carbon footprint of individual application in a data center’ can include the steps and methodology to identify individual carbon footprint of each application running in the data center. Processes described herein can apply the carbon footprint calculation process as defined by Green House Gas (GHG) Protocol and map it to an individual application.

Capital expenditure or capital expense (CapEx) is the money an organization or corporate entity spends to buy, maintain, or improve its fixed assets, such as buildings, vehicles, equipment, or land. It is considered a capital expenditure when the asset is newly purchased or when money is used towards extending the useful life of an existing asset.

Carbon footprint (e.g. greenhouse gas footprint) is a calculated value or index that makes it possible to compare the total amount of greenhouse gases that an activity, product, company or country adds to the atmosphere. Carbon footprints can be reported in tons of emissions (e.g. CO2-equivalent) per unit of comparison, by way of example.

Cloud computing can be the on-demand availability of computer system resources, especially data storage (e.g. cloud storage) and computing power, without direct active management by the user. Cloud service provider (CSP) is an entity that provides computing resources. These computing resources can be on-demand, scalable. Example computing resources include, inter alia: computing power, data storage, or applications over the internet.

Data center can be a building/structure and/or other dedicated space within a building/structure and/or a group of buildings used to house computer systems and associated components, such as, inter alia: telecommunications and storage systems.

Data center application can be deployed in a data center which could be in a Cloud, Multi-Cloud (e.g. involving one or more clouds), Hybrid (e.g. involves Cloud and On-Premise), Bare-metal on premise or an on-premise cloud (e.g. AWS Outpost®, Google Anthos®, Azure Azurestack®, Openshift®, Openstack®, etc.).

Greenhouse gases (GHGs) are the gases in the atmosphere that raise the surface temperature of planets such as the Earth. GHGs absorb the wavelengths of radiation that a planet emits, resulting in the greenhouse effect.

Operating expense (OpEx) can be an ongoing cost for running a product, business, and/or system.

Platform as a service (PaaS) is a category of cloud-computing services that allow customers to provision, instantiate, run, and manage a modular bundle comprising a computing platform and one or more applications, without the complexity of building and maintaining the infrastructure typically associated with developing and launching the application(s), and to allow developers to create, develop, and package such software bundles.

Task can be a unit of execution of a software feature. An application can have several tasks some taking as little as milliseconds while others could take hours.

### Example Systems and Methods

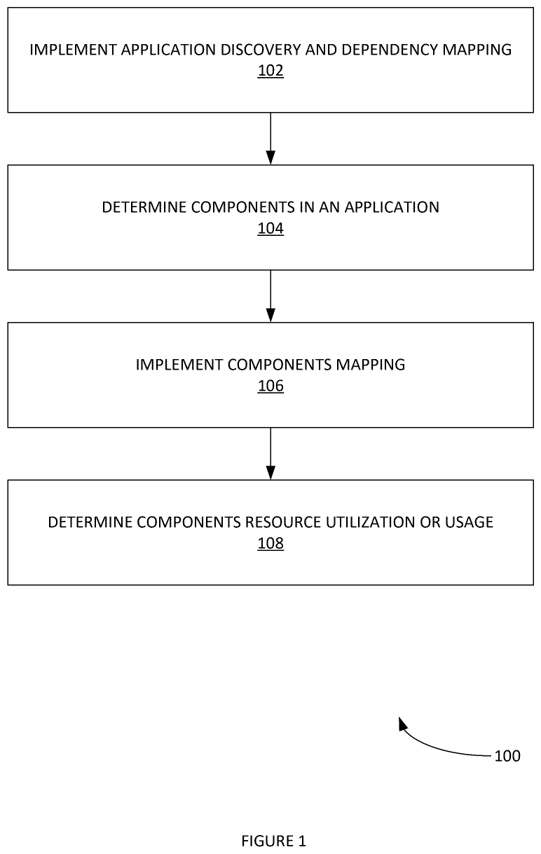

FIG. 1 illustrates an example process 100 for calculating a carbon footprint of an individual application in a data center, according to some embodiments. Process 100 can be used to reduce cost, carbon footprint, and risk increase performance and compliance improved understanding of application and workload utilization/usage. Process 100 is for identifying the carbon footprint at the application level and not the infrastructure or services level.

In step 102, process 100 implements Application Discovery and Dependency Mapping (ADDM). In some embodiments, the ADDM can be running continuously and maintains a graph (e.g. an ADDM graph, etc.) in an updated state.

In step 104, process 100 determines components in an application. Hardware components that can be determined can include Infrastructure-as-a-Service (IaaS). Components can also include, inter alia: servers, containers, virtual machines, etc. Additional components can include storage system such as storage on physical media, object storages (e.g. AWS S3), network attached storage, etc. Other components can include networking systems such as load balancers, software defined network, virtual private cloud, etc. Software components can include software deployed on infrastructure (e.g. BareMetal, VMs) or Platform-as-a-Service (PaaS) offerings in the cloud such as, inter alia: Database, Cache, Serverless, Kubernetes, big data, Spark, streaming analytics, etc.

In step 106, implement components mapping. Results of the ADDM operations can include a graph. The individual components can be represented as nodes and the connectivity between the nodes represented as edges. Based on the knowledge of the data-center environment, each component (e.g. nodes and edges) can be identified to correspond to hardware, software, IaaS or PaaS based on the network address. It is noted that some of the components could be transient.

In step 108, process 100 can determine components resource utilization or usage. Once the component is identified, the utilization (e.g. in an IaaS context) and/or usage (e.g. in a PaaS context) of all the attributes of this component are captured and reported as an average per hour, per day, per week, per month, etc. It is noted that smaller intervals can be used as well (e.g. smaller intervals of 5 mins or 15 mins too can be considered). An example of a node component can be a VM instance. An example of an edge component can be a network.

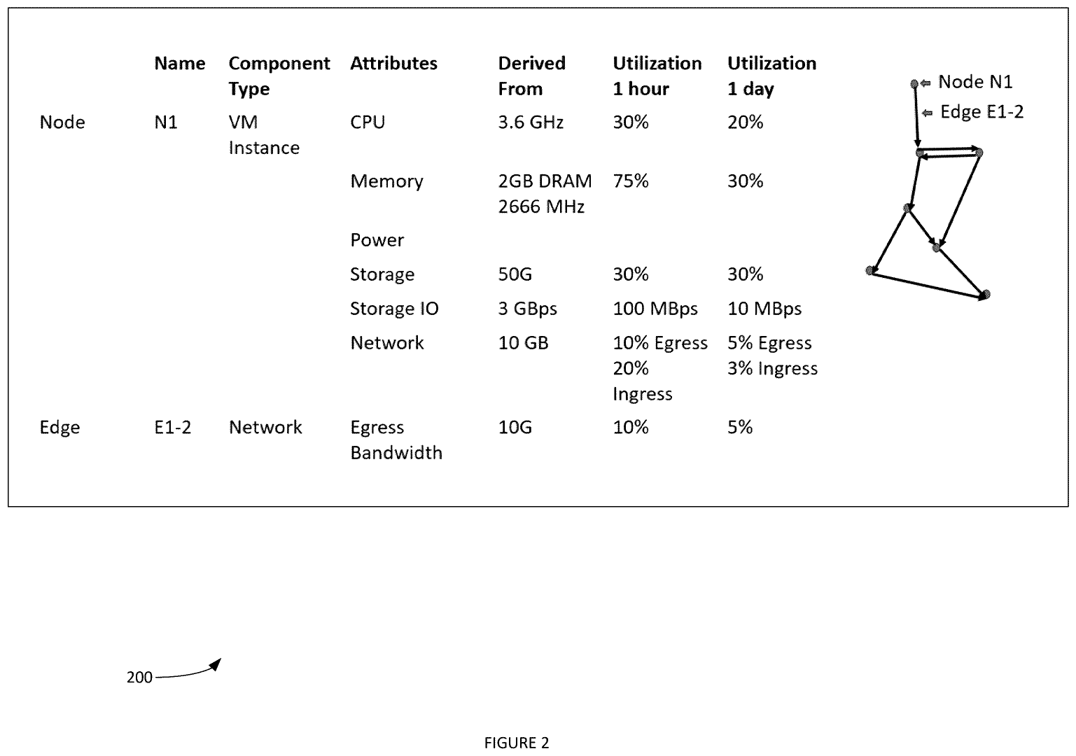

FIG. 2 illustrates an example table of components resource utilization for IaaS model, according to some embodiments. This could be a compute instance (a VM) which can have specific type of CPU having an average utilization for an hour or a day, similarly it could be memory for the compute with a specific amount and specific usage and also specific speed or could be an edge or a network between two components which certain capacity (10G or 40G) with an average utilization.

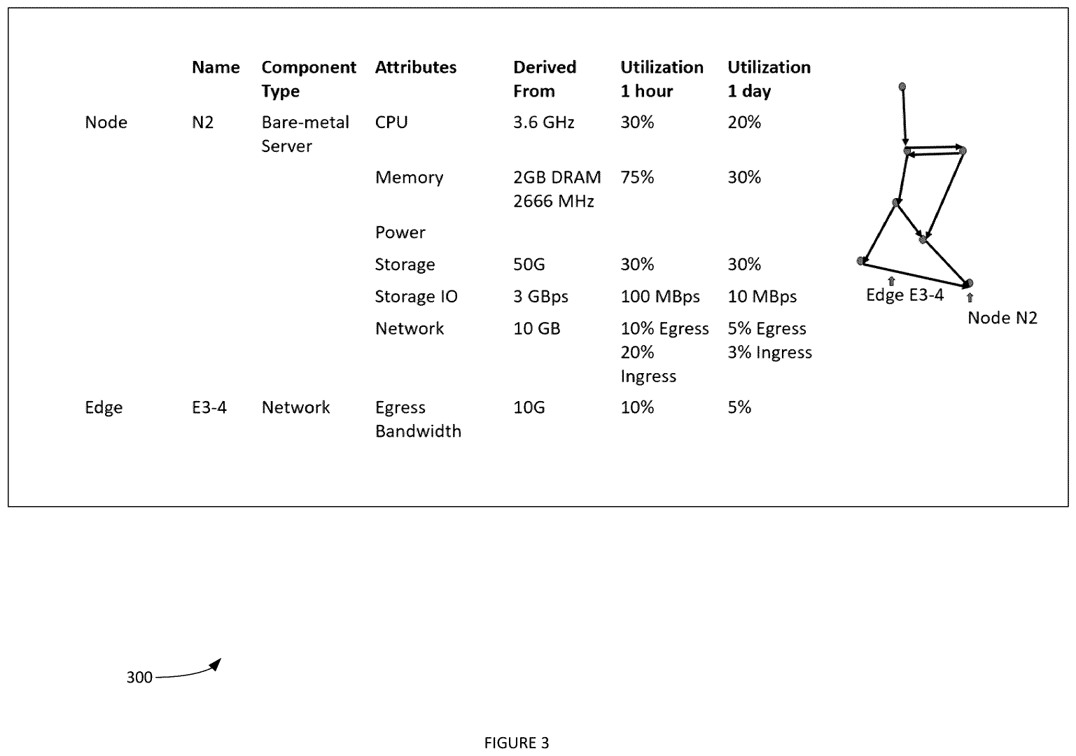

FIG. 3 illustrates an example table of components resource utilization for on-premise model, according to some embodiments. On premise could be similar to IaaS as well with resources associated with each component such as a server having specific type of CPU, Memory or storage and they are running with a specific average utilization or an edge specifying the network between to components which would be a specific type (10G or 40G or 100G) and running with a specific average utilization.

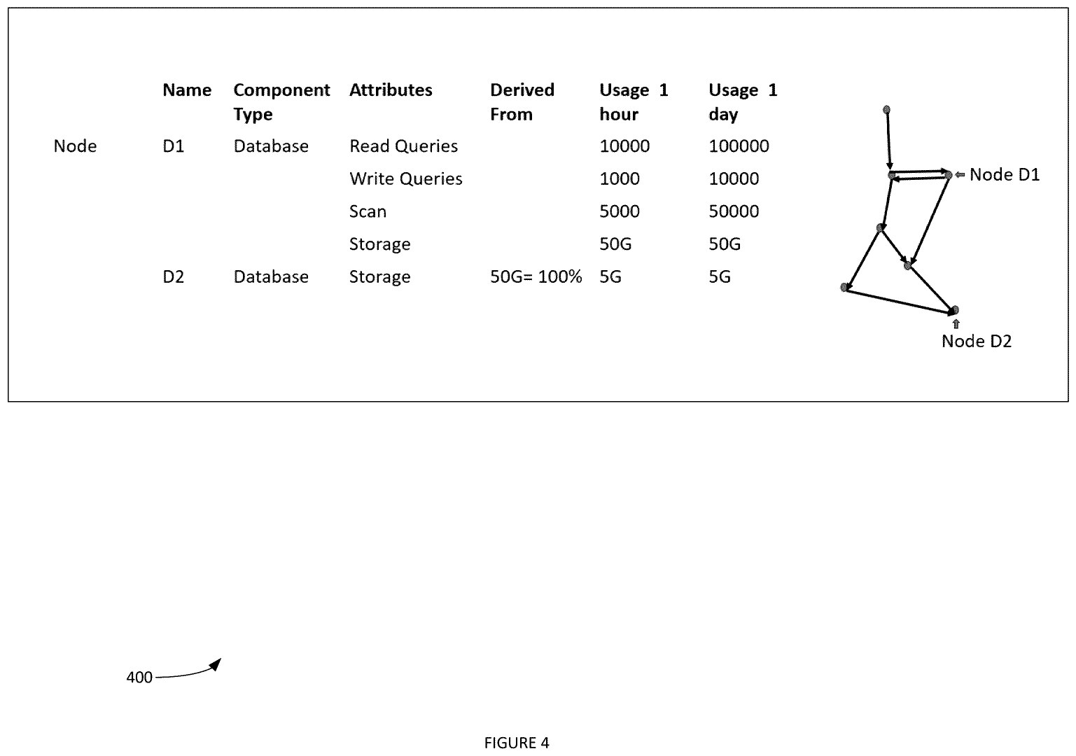

FIG. 4 illustrates an example table of components resource usage for PaaS model, according to some embodiments. With PaaS, unlike IaaS or On-premise where component types and their average utilization is calculated, with PaaS model, average usage of a functionality or a feature is calculated. This could be number of database calls made or number of API calls made.

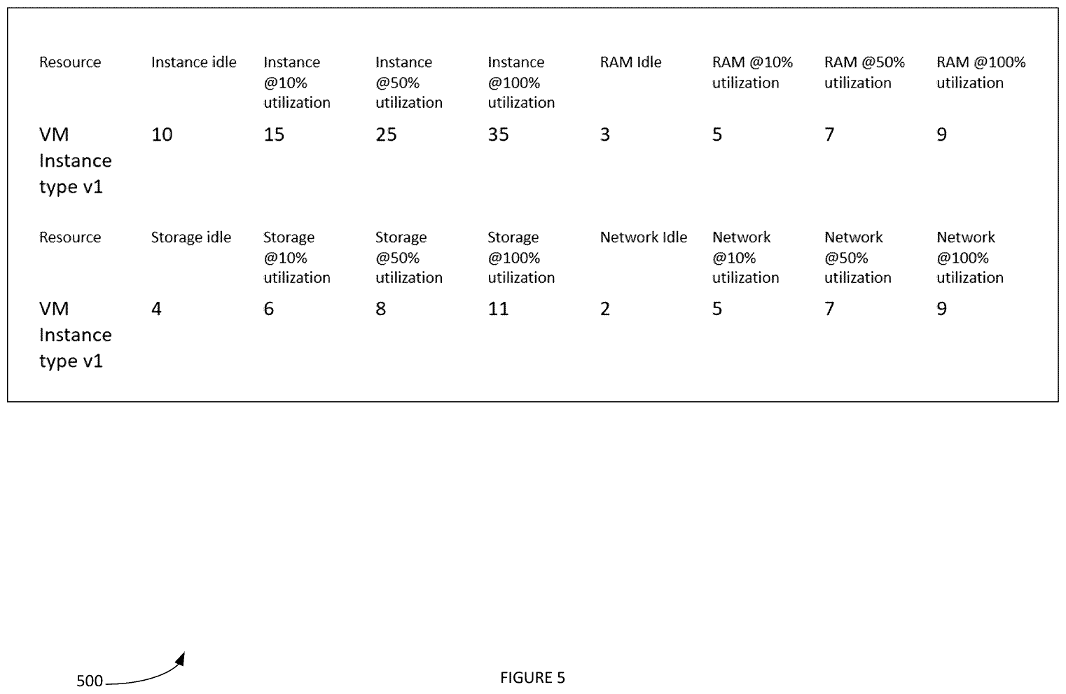

FIG. 5 illustrates an example table of energy consumed in kw (kilo watt) for one (1) hour over average utilization specified, according to some embodiments. In one example, a virtual machine (VM) instance running CPU utilization of 10%, with memory utilization at 50%, having attached Storage utilized at 10% and Network utilized at 10% consumes total wattage of 15+7+6+5=23 kw over the last one (1) hour. Similarly electricity metering for a bare-metal server on premise can be calculated at different utilization for different specifications (different CPU types, different memory, storage) averaged over 1 hour (and other time periods)

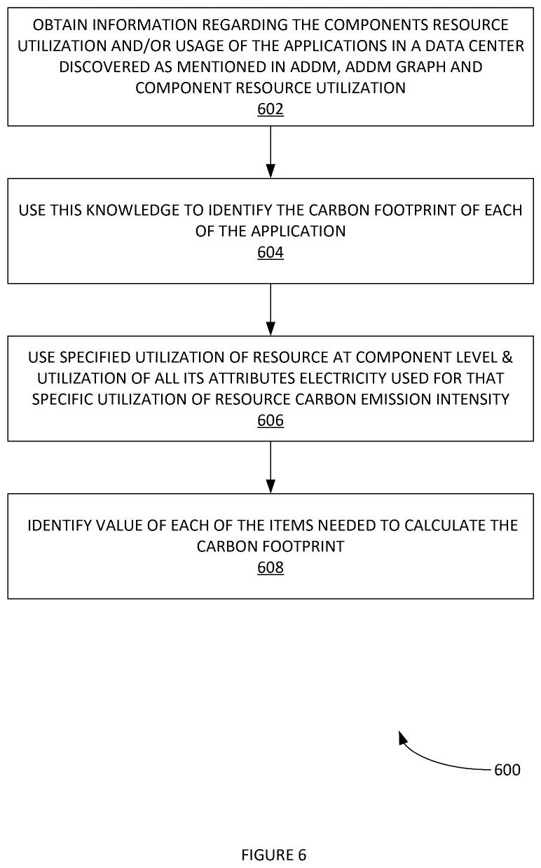

FIG. 6 illustrates an example process 600 for using components resource utilization and/or usage of the applications in a data center discovered to identify the Carbon footprint of each of the application, according to some embodiments. In step 602, process 600 obtains information regarding the components resource utilization and/or usage of the applications in a data center discovered as mentioned in ADDM, ADDM graph and Component Resource Utilization.

In step 604, process 600 uses this knowledge to identify the carbon footprint of each of the application. The carbon footprint of each of the application can be derived for various time intervals/periods. For example, derived for last one (1) hour, last one (1) day, last one (1) week, last thirty (30) days and so on.

To calculate the carbon footprint of the application, process 600 uses a specified utilization of the resource at component level and the utilization of all its attributes electricity used for that specific utilization of the resource Carbon Emission Intensity in step 606. In some embodiments, this can be a measure of grams equivalent of CO2 released per kilowatt-hour of electricity. It is noted that Carbon Emission Intensity can vary throughout the data if more solar is used during day and other energy resource used to generate electricity during night.

In step 608, process 600 identifies the value of each of the items needed to calculate the carbon footprint. This can include information about the utilization of the resource at component level and the utilization of all its attributes. This value can be provided by a Components Resource Utilization methodology in step 610 which calculates average utilization for a specified period (e.g. the last one (1) hour, last one (1) day, etc.). This method provides for each component, what is the utilization of various attributes of the components (e.g. for the last one (1) hour, last one (1) hour the VM instance had CPU at 25% average utilization and memory at 50% utilization and 10% disk access and 50% network usage, etc.).

It is noted that here idle, 10%, 50% and 100% can be taken. More finer values such as percentages at 5, 10, 15, 20, 25, etc. can be calculated for each attribute to get more precise values electricity used for that specific utilization of the resource. These can be energy constants or energy coefficients which are made public by the cloud service providers for different resources at varying load or utilization (e.g. instance types, services, etc.). If this information is not made public and/or otherwise available, this can be calculated manually on individual bare-metals servers and/or in storage systems to determine the applicable energy consumption that is then mapped to a specific instances or resource. The energy constants can a table that provides for a particular type of instance (e.g. and/or other resource), these are the power in kw (kilo watt) consumed at various utilization. That is, for example, when VM instance is idle, instance is at 10% CPU utilization, the instance can be at 50% CPU utilization and at 100% CPU utilization (e.g. average utilization over one (1) hour, one (1) day or other time period, etc.) and the energy usage of the component can be calculated and on that instance. This can determine what is the kilo watt for just memory when memory is at idle, 10%, 50% and 100% at usage over one (1) hour and/or a varying time period. This can determine what is the kilo watt for drives when 10 being exercised at idle, 10%, 50% and 100% usage over one (1) hour and/or a varying time period. This can determine what is the kilo watt for network when network is being exercised at idle, 10%, 50% and 100% usage over one (1) hour and varying time period. In one example, the energy consumed in kw (kilo watt) for one (1) hour over average utilization specified can be calculated.

Carbon Emission Intensity can be a measure of grams equivalent of CO2 released per kilowatt-hour of electricity. Carbon Emission Intensity can vary throughout the data if more solar is used during day and other energy resource used to generate electricity during night. This is publicly available information from each city or location in the world as to how much of the electricity produced in each location, what is the CO2 released in grams when producing kilowatt-hour (kWh) of electricity expressed in gCO₂eq/kWh.

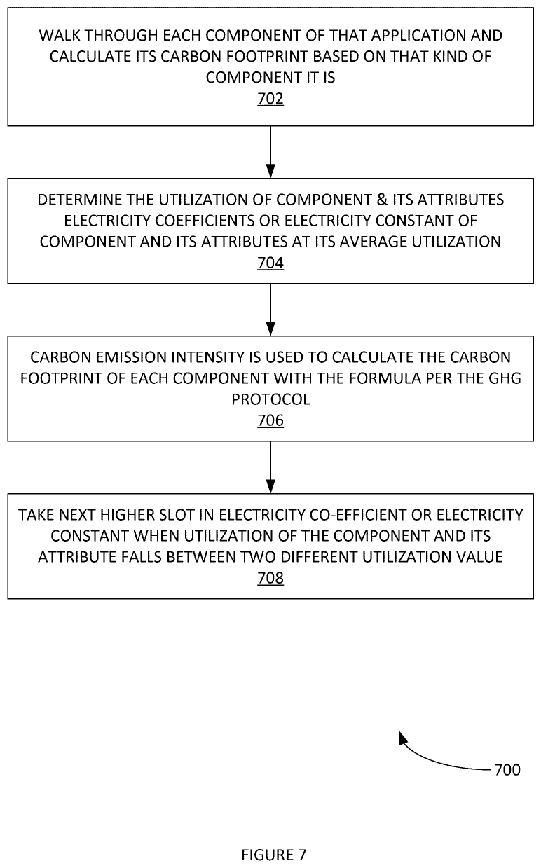

FIG. 7 illustrates an example process 700 for Carbon Footprint Calculation of the Application, according to some embodiments. To identify the carbon footprint of an individual application (for the last one-hour, last one-day, last one-week, etc.). Process 700 can walk through each component of that application and calculate its carbon footprint based on the kind of component it is (e.g. IaaS or PaaS or on-premise bare-metal, etc.) in step 702. Process 700 determines the utilization of the component and its attributes Electricity coefficients or electricity constant of the component and its attributes at its average utilization for the last one-hour (e.g. and so on and/or based on another specified time interval) in step 704.

If PaaS is used by various different applications, Cloud Providers which are providing PaaS provide overall carbon footprint based on their product (such as PaaS) for the account, process 700 can use this to identify what fraction of the total PaaS calls from all the applications in the account did the specific application make in the last 1 hour or last 1 day and use that fraction as the fraction of the monthly carbon emission as reported by the cloud provider for the account.

Carbon Emission Intensity is used to calculate the carbon footprint of each component with the formula per the GHG protocol in step 706. In step 708, process 700 can take the next higher slot in electricity co-efficient or electricity constant when the utilization of the component and its attribute falls between two different utilization value.

For example, if the average CPU utilization for last one hour is thirty-five percent (35%), process 700 obtains the electricity constant of higher value of utilization which is at fifty percent (50%) instead of the lower value which is at ten percent (10%). This can be so as to not undervalue the carbon emission. When electricity constants are calculated at smaller differences, more accurate carbon footprint can be calculated.

Process 700 can aggregate the carbon footprint of all the components calculated in the above step to obtain the overall carbon footprint of the each of the applications for the last one-hour in step 710. This methodology is repeated for different time intervals (last 1 day, last 1 week, last 1 month, etc.) in step 712.

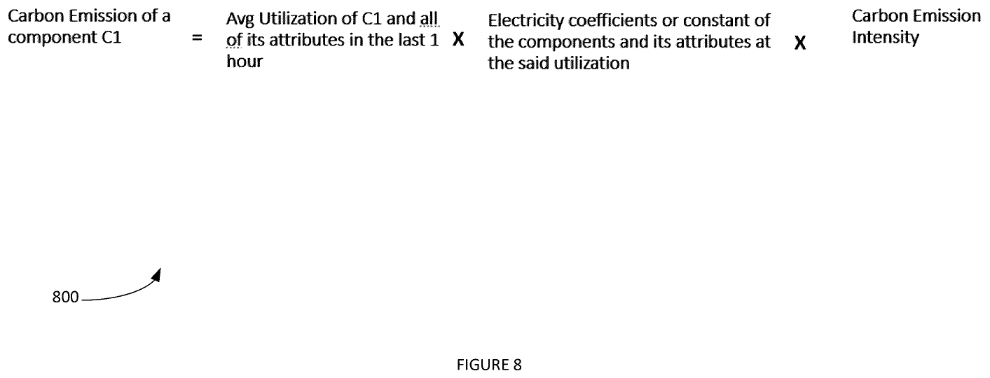

FIG. 8 illustrates an example equation 800 for calculating the carbon footprint of each component with the formula per the GHG protocol, according to some embodiments. Equation 800 can be utilized, when applicable, by the methods and processes provided supra.

When one example, an application implementing the methods and systems provided herein can be deployed in a data center, in a Cloud, Multi-Cloud (e.g. involving one or more clouds), Hybrid (e.g. which involves Cloud and On-Premise), Bare-metal on premise or an on-premise cloud (e.g. AWS Outpost, Google Anthos, Azure Azurestack, Openshift, Openstack).

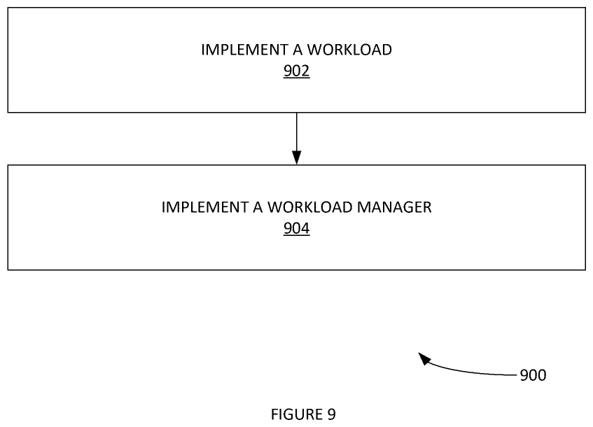

FIG. 9 illustrates an example process 900 for analysis of workloads, according to some embodiments. In step 902, process 900 can implement a workload (e.g. or a job). A workload is a collection of one or more tasks which are performed over a time period towards a specific goal. These tasks can be happening one after another in serial fashion or some disconnected tasks could be in parallel, but all are progressing step by step to achieve one or more end result(s) in the of case of a batch work load (e.g. shell script running daily maintenance) and/or could be continuously updating one or more end result(s) in case of real-time workload (e.g. streaming-analytics from IoT devices giving health updates).

A workload can span across multiple applications executing tasks from these various applications. Examples of tasks could include and not limited to data collection, streaming analytics, database query, analyzing data, data cleansing, running AI functions, reporting.

In step 904, process 900 can implement a workload manager. A workload manager executes the tasks in the workload. The path of execution of these task is defined as the workflow. The workload manager could be a simple shell script calling one task after the other an automation framework any methodologies or processes used to manage workload anything that verifies the status of a task and restart the task as needed.

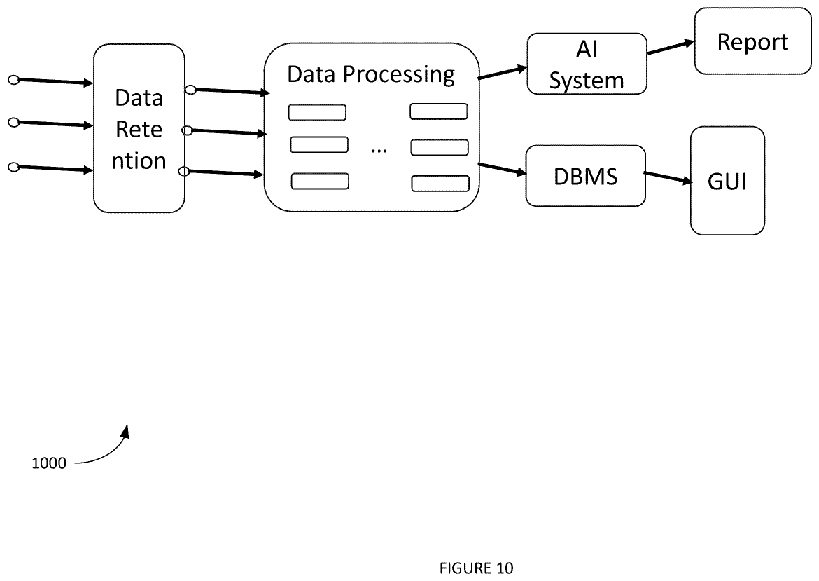

FIG. 10 illustrates another example process for, according to some embodiments. Process 1000 can be used to inform implementations of process 900 in some examples.

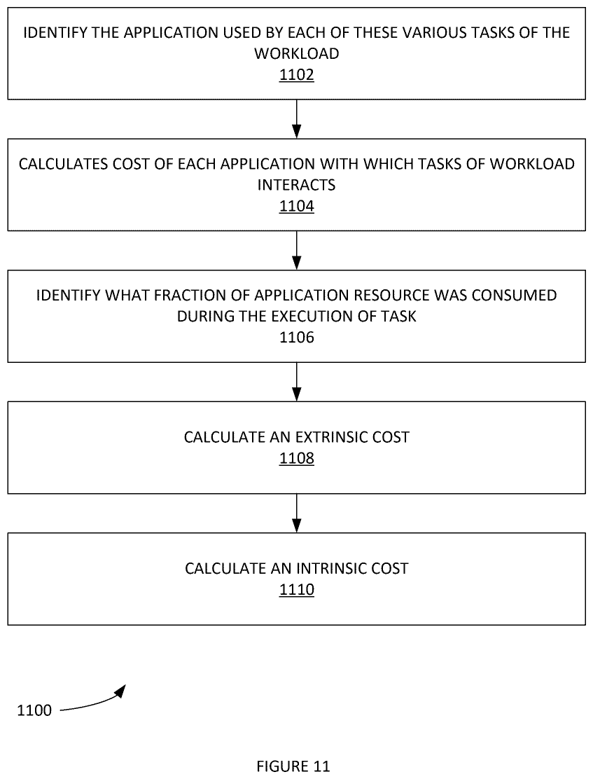

FIG. 11 illustrates an example process 1100 for calculating a cost of a workload in a data center, according to some embodiments. It is noted that calculating the cost of a workload in a data center describes steps and methodology to identify individual cost of a workload running in the data center.

Process 1100 identifies cost of running a workload. To identify the cost of running a specific workload, process 1100 identifies all the various tasks which are part of the workload, this is managed by workload manager Identify the application used by each of these various tasks of the workload in step 1102. Process 1100 calculates the cost of each application with which the tasks of the workload interacts with a method or system for optimizing carbon footprint assessment for individual applications in data centers in step 1104. Process 1100 identifies what fraction of the application resource (e.g. utilization when using infrastructure or usage in when using services) was consumed during the execution of the task in step 1106.

The total cost of the workload is the summation of the fraction of the application cost of all tasks running across various applications. Here, the total cost of the workload is calculated as two different costs. Process 1100 can calculate an extrinsic cost in step 1108. The extrinsic cost can be where the cost of the workload varies based on how well the applications are utilized with multiple jobs. Process 1100 can calculate an intrinsic cost in step 1110. The intrinsic cost can be an absolute cost of the workload where the workload cost is largely independent of other workloads using the same resources and doesn't drastically vary when more workloads are using same resource.

Both the extrinsic cost and intrinsic cost are important as extrinsic cost tells how well the resources are used or whether the resources are over-provisioned heavily. The intrinsic cost can be used to identify actually how much the workload cost and can be used as a measure to migrate workloads to cheaper options.

Here, the extrinsic cost of the workload or job is calculated as what fraction of the entire applications was used by each task compared to all other tasks. If only one task was running in the application, its extrinsic cost is 100% of the application cost for that time duration of the cost. If two tasks A and B were running on the application and if task B uses 2 times more resource than task A, extrinsic cost of task A=x/(2x+x)*cost of application for that time duration of the cost. For example, when no tasks are running on the application, if the baseline utilization is ‘x’.

Extrinsic cost of the workload or job is calculated as what fraction of the entire applications was used by each task compared to all other tasks. If only one task was running in the application, its Extrinsic cost is 100% of the application cost for that time duration of the cost If two tasks A and B were running on the application and if task B uses 2 times more resource than task A, extrinsic cost of task A=x/(2x+x)*cost of application for that time duration of the cost.

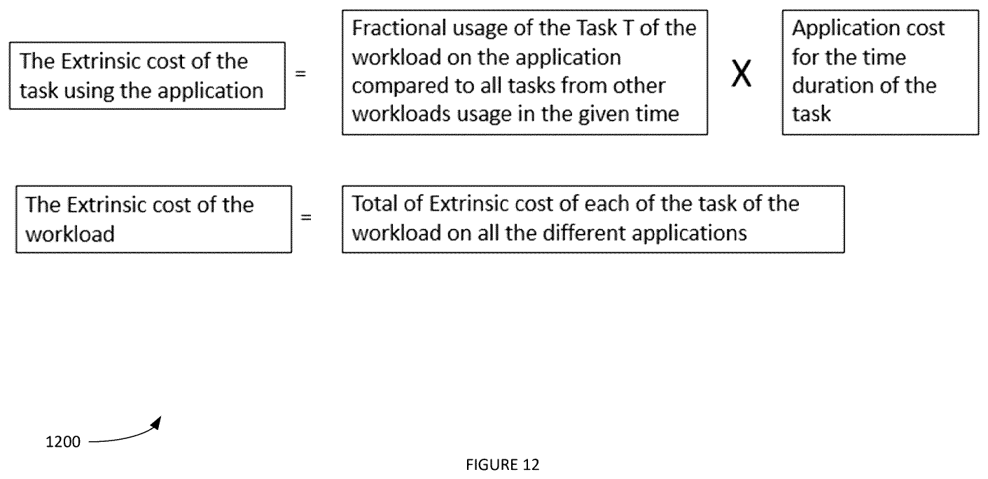

FIG. 12 illustrates another example of an equation for calculating an extrinsic cost, according to some embodiments. The extrinsic cost of the workload is calculated as, if ‘N’ is the total number workloads whose task is using the application ‘A’, then what fraction of the total usage of resource of ‘A’ was this specific task ‘T’ of Workload ‘W’ using compared to other workload tasks during the specific time period. The fraction calculated is multiplied with the total cost of the application ‘A’ for that time period. This step is repeated for all the tasks of the workload. Extrinsic cost for a workload varies with how much of a fraction of the resource was used and reduces with more utilization.

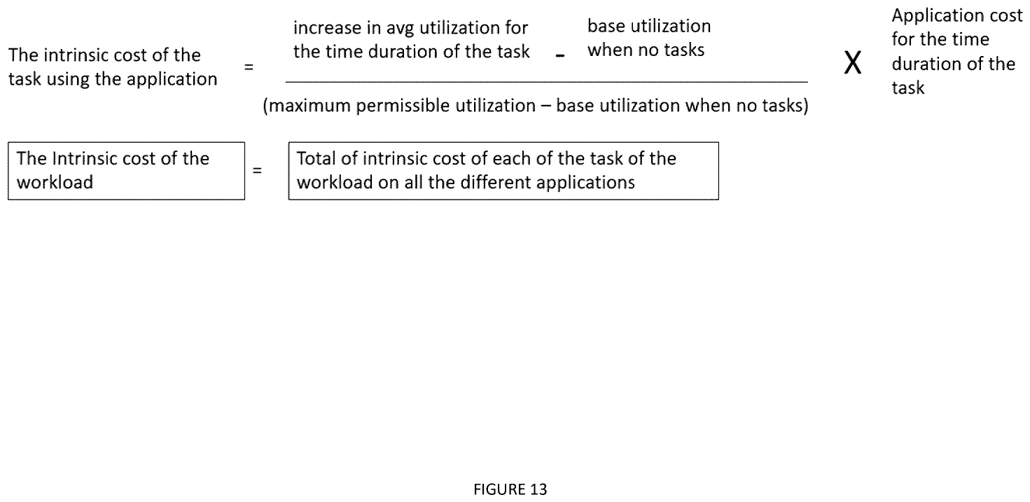

FIG. 13 illustrates an example equation(s) for calculating an intrinsic cost, according to some embodiments. Intrinsic cost of a workload in the set applications is the utilization of the resources or usage of services that each task introduces on the various applications and the cost of that utilization.

An example is now discussed. If the workload A spans across 4 applications, if the base line of the resource when no jobs (or workloads) are running is 20% of average CPU utilization (this could be different for different applications like, for example: network utilization, memory, 10 bandwidth, IOPS or a combination based on the application type of being CPU intensive or CPU and Memory intensive). These can run on each for 5 mins, and the tasks introduces in these applications increase in average CPU utilization to be 30%, 40%, 50% and 60%, and the cost of each application is $100, $200, $300 and $400 for 1 hour, then the intrinsic cost of the workload takes into consideration. Maximum utilization of the resource before more resource is added, that is, for instance, in a data center, typically CPU util is kept under 80% or 90% utilization. The new jobs introduced can be from 20% base utilization to 90% utilization. This newly introduced utilization against the maximum allowed is used for the calculation of the cost of fraction of the application cost.

In this case, for first task where utilization is 30%, increase is 30−20=10% Maximum permissible CPU utilization is 90% (example). Here, the fraction of application utilization is 10/(90−20)=10/70 Application cost for 5 mins=(5/60)*100=8.33. Cost of the first task=(10/70)*(5/60)*100=$1.19 (for the first task). Similarly, Cost of the 2nd task=((40−20)/70)*(5/60)*200=$4.76 (for the 2nd task) Cost of the 3rd task=((50−20)/70)*(5/60)*300=$10.71 (for the 3rd task) Cost of the 2nd task=((60−20)/70)*(5/60)*400=$19.04 (for the 4th task) Total Intrinsic cost of the workload A=1.19+4.76+10.71+19.04=$35.7.

### Optimization of a Ratio to Identify if an Application is Over-Provisioned or Under-Provisioned in a Data Center

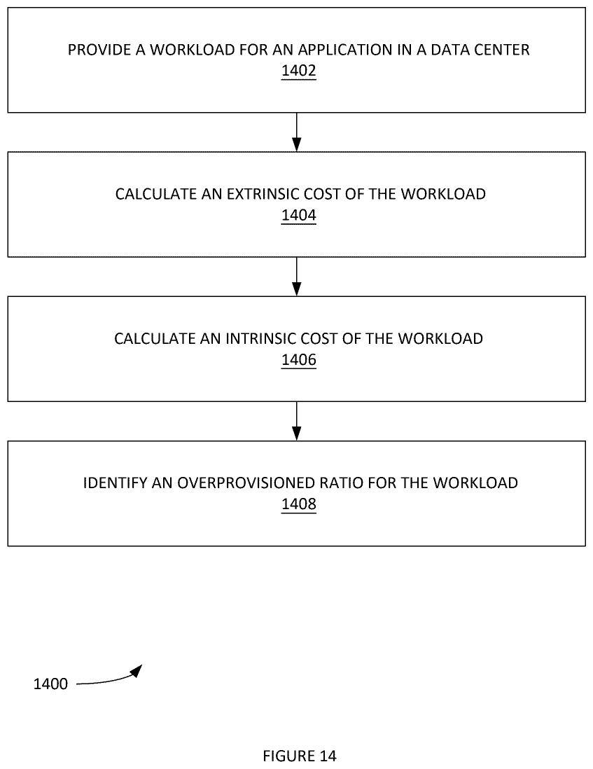

FIG. 14 illustrates an example process 1400 to determine and optimize a ratio to identify if an application is over-provisioned or under-provisioned, according to some embodiments. Process 1400 describes steps on how to identify if one or more applications, and one or more workload, in the data center is over-provisioned or under-provisioned or rightly provisioned.

In step 1402, process 1400 provides a workload for an application in a data center. In step 1404, process 1400 calculates an extrinsic cost of the workload. In step 1406, process 1400 calculates an intrinsic cost of the workload. In step 1408, process 1400 identifies an overprovisioned ratio for the workload. In one example, the overprovisioned ratio of the workload is determined by: overprovisioned ratio for a workload equals the extrinsic cost of workload divided by the intrinsic cost of workload or a permutation thereof.

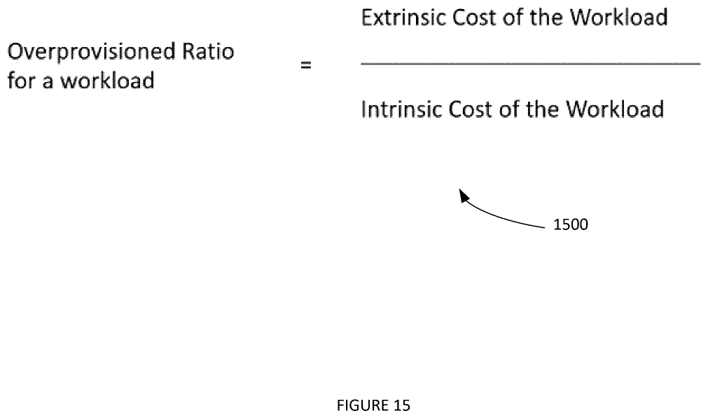

FIG. 15 illustrates an example equation 1500 for determining an overprovisioned ratio for a workload, according to some embodiments. As noted supra, the overprovisioned ratio for a workload can equal (Extrinsic cost of workload/Intrinsic cost of workload). The higher the ratio the larger the overprovisioning. In some embodiments, the following rule can be utilized by way of example. When the overprovisioned ratio is >1.5 and <2.5=>, most applications involved with the workload are correctly provisioned. When the overprovisioned ratio is >2.5=>One or more Applications involved with the workload are over-provisioned for the workload. When the overprovisioned ratio is <1.5=>, one or more Applications involved with the workload could be under-provisioned.

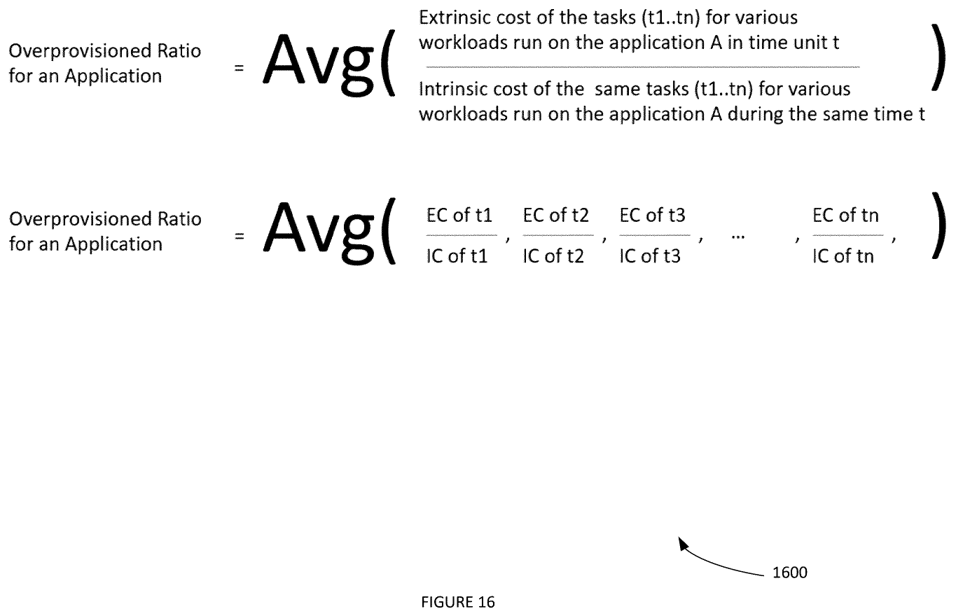

FIG. 16 illustrates another example set of equations for determining an overprovisioning for a workload, according to some embodiments.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method for determining a ratio to identify when an application is over-provisioned or under-provisioned in a data center in a data center comprising:
performing Application Discovery and Dependency Mapping (ADDM) of one or more individual applications of the data center;
with an ADDM output from the ADDM, generating an ADDM graph;
determining each component of each individual application of one or more individual applications of the data center, wherein a component comprises a hardware component or a software component of each individual application;
implementing a components mapping of each component of each individual application into the ADDM graph, wherein, with the ADDM graph, a plurality of components are represented as nodes and the connectivity between the nodes represented as edges, wherein based on a knowledge of the data-center environment, wherein each component is identified to correspond to each hardware component or each software component;
implementing a workload in the data center, wherein the workload comprises a set of one or more tasks which are performed over a time period towards a specific goal;
implementing a workload manager, wherein the workload manager executes the set of tasks in the workload, wherein a path of execution of the set of tasks is defined as the workflow;
with the ADDM, ADDM graph and Component Resource Utilization, for the application:
calculating a cost of each workload of the application;
calculating a cost of running the application in the data center based on the cost of each workload of the application; and
determining a ratio to identify when the application is over-provisioned or under-provisioned in the data center.

2. The method of claim 1, wherein the ratio to identify when the application is over-provisioned or under-provisioned in the data center comprises:
the ratio for a workload equals the extrinsic cost of workload divided by the intrinsic cost of workload.

3. The method of claim 2, wherein a higher value for the ratio then there is a higher level of overprovisioning of the workload.

4. The method of claim 3, wherein a rule for determining when the application is over-provisioned or under-provisioned in the data center comprises when the overprovisioned ratio is greater than 1.5 and less than 2.5 then the applications involved with the workload is correctly provisioned.

5. The method of claim 4, wherein a rule for determining when the application is over-provisioned or under-provisioned in the data center comprises when the overprovisioned ratio is greater than 2.5 than application involved with the workload are over-provisioned for the workload.

6. The method of claim 5, wherein a rule for determining when the application is over-provisioned or under-provisioned in the data center comprises when the overprovisioned ratio is less than 1.5 than application involved with the workload are over-provisioned for the workload.

7. The method of claim 1, wherein the set of tasks of the workload are implemented one after another in serial fashion as the workflow.

8. The method of claim 1, wherein the set of tasks of the workload comprises a set of disconnected tasks implemented in parallel and all progress step by step to achieve the specified goal as the workflow.

9. The method of claim 1, wherein the step of calculating the cost of running the workload in the data center further comprises:
calculating an extrinsic cost of running the workload in the data center.

10. The method of claim 9, wherein the step of calculating the cost of running the workload in the data center further comprises:
calculating an intrinsic cost of running the workload in the data center.

11. The method of claim 9, wherein the step of calculating the cost of running the workload in the data center further comprises:
calculating a total cost of the workload is calculated as a sum of the extrinsic cost and the intrinsic cost of the workload.

12. The method of claim 11, wherein the workload manager provides a real-time monitoring tool for the workload costs.

13. The method of claim 12, wherein the extrinsic cost of a workload is calculated as what fraction of the entire applications was used by each task compared to all other tasks.

14. The method of claim 13, wherein the extrinsic cost of the workload is further calculated as what fraction of the entire applications was used by each task compared to all other tasks.

15. The method of claim 14, wherein the extrinsic cost of the workload varies with how much of a fraction of the resource was used and reduces with more utilization.

16. The method of claim 15, wherein the intrinsic cost is the utilization of the resources or usage of services that each task introduces on the various applications and the cost of that utilization.
